(19) United States
(12) Patent Application Publication
(10) Pub. No.: US 2010/0119020 A1
(43) Pub. Date: May 13, 2010

(54) Blanking Techniques in Receivers

(75) Inventors: Bijoy Bhukania, Bangalore (IN); Jawaharlal Tangudu, Bangalore (IN); Karthik Ramasubramanian, Bangalore (IN); Arun Raghupathy, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/505,553

(22) Filed: Jul. 20, 2009

(30) Foreign Application Priority Data
Nov. 11, 2008 (IN) 2763/CHE/2008

(51) Int. Cl. H04B 1/10; H04L 27/08

(52) U.S. Cl. 375/345; 375/348

(57) ABSTRACT

An aspect of the present invention detects the presence of interference by examining an input signal received on an input path, and blanks the receiver if interference is detected. Information contained in the input signal may be recovered otherwise. In an embodiment, the duty cycle of a jamming signal is determined by examining the input signal, and a threshold strength having a positive correlation with the duty cycle is determined. If the strength of the jamming signal during the on-interval (start and end of the interference in each cycle) is greater than the threshold strength, then only the receiver is blanked. Otherwise, no blanking is performed, and only the gain of an amplifier in the path from the input path to a baseband processor is reduced. According to another aspect, one or more cycles of the interference is used to detect the start of interference and the receiver is blanked when interference is present.

### RELATED APPLICATION(S)

The present application claims the benefit of co-pending India provisional application serial number: 2763/CHE/2008, entitled: “An automatic Blanking Strategy for GPS Receivers”, filed on Nov. 11, 2008, naming Texas Instruments, Inc. (the intended assignee of this U.S. application) as the Applicant, and naming the same inventors as in the present application as inventors, attorney docket number: TXN-243, and is incorporated in its entirety herewith.

### BACKGROUND OF THE INVENTION

1. Technical Field

Embodiments of the present disclosure relate generally to receivers used in communication devices, and more specifically to blanking techniques in receivers.

2. Related Art

A receiver refers to a component which receives a modulated signal bearing information, as an input signal, extracts the information (by demodulation) from the modulated signal and provides the information for further processing. For example, a GPS (global positioning system) receiver receives modulated signals from satellites, extracts the information contained in the received input signal, and provides the extracted information for determination of the position (geographical coordinates, for example, in terms of longitude and latitude) of the receiver.

Blanking techniques are often employed in receivers. As is well known in the relevant arts, blanking refers to blocking the input signal (containing potentially both of the modulated signal and interference/jamming signal) from being provided to one or more internal components of the receiver upon the occurrence of an undesirable state in the input signal. For example, blanking is implemented in GPS receivers to force signal/data inputs (provided to various components) to ground (or provide binary zeros as inputs) when a transmitter indicates a time duration in which a signal is being transmitted. The receiver is blanked in view of the possibility that the transmitted signal may contain interference (jamming signals). Well known situations in which such jamming signals may be produced include durations when GSM, WLAN, CDMA types of transmitters transmit corresponding signals.

By blanking the receiver, the jamming signal is prevented from causing various undesirable effects in receivers. For example, the a GPS receiver may be prevented from interpreting a jamming signal (received in addition to satellite signals in the input signal) as having valid content, and thereby from potentially computing a wrong position and/or from failing to detect a satellite signal that is present in the input signal. As an illustrative example, some GPS receivers are designed to extrapolate a present position based on previously computed positions in the absence of input signal, and by forcing the input signal to ground, the GPS receiver treats the situation as absence of input signal. Accordingly, an extrapolated position is provided as the present position until valid input data is received on the input signal. In some other GPS receivers, saturation of components such as amplifiers, may be prevented by blanking the input signal.

It is generally desirable that receivers not be blanked when not necessary such that the information in the input signal can be effectively used.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An aspect of the present invention detects the presence of interference by examining an input signal provided to the receiver, and blanks the receiver if interference is detected. Information contained in the input signal may be recovered otherwise. By detecting the presence of interference based on the content of the input signal within the receiver itself, the need for external indicators of interference (e.g., by a separate path) are avoided.

In an embodiment in which the interference is periodic (e.g., as in GSM based interference), the period of the interference, the start and end time points (of the interference) in each period/cycle are also determined by examining the input signal. The information may be used to blank the receiver only during ON-intervals of each cycle thereafter.

According to another aspect, the duty cycle of an interference is determined by examining the input signal, and a threshold strength having a positive correlation with the duty cycle is determined. If the amplitude of the jamming signal during the on-interval (of the duty cycle) is greater than the threshold strength, only then is the receiver blanked, in addition to reduction in gain of an amplifier in the path from the input path to a baseband processor. Otherwise, only the gain of an amplifier in the path from the input path to a baseband processor is reduced.

Thus, in such an embodiment, a baseband processor may receive samples (with such reduced amplitude) and still be able to recover the information in the input signal when only low level of interference is present.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### BRIEF DESCRIPTION OF THE VIEWS OF DRAWINGS

Example embodiments of the present invention will be described with reference to the accompanying drawings briefly described below.

FIG. 1 is a block diagram of an example device in which several aspects of the present invention can be implemented.

FIG. 2 is a block diagram of a receiver in an embodiment of the present invention.

FIG. 3 is a flowchart illustrating the manner in which a receiver is blanked in an embodiment of the present invention.

FIG. 4 is a diagram used to illustrate jamming interference and measurement detection windows in a receiver, in an embodiment of the present invention.

FIG. 5 contains a table showing the relationship between duty cycle of a jamming signal and corresponding threshold strengths to be used in providing blanking, in an embodiment of the present invention.

FIGS. 6A and 6B are example waveforms illustrating interference mitigation provided in an embodiment of the present invention.

The drawing in which an element first appears is indicated by the leftmost digit(s) in the corresponding reference number.

### DETAILED DESCRIPTION

Various embodiments are described below with several examples for illustration.

1. Example Device

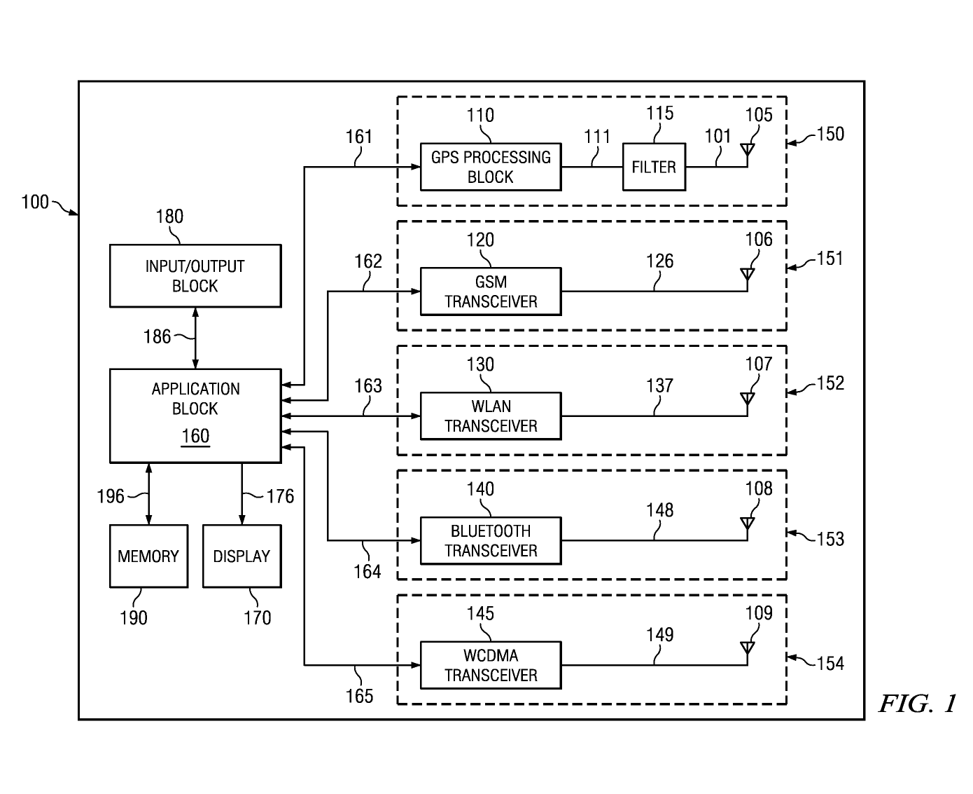

FIG. 1 is a block diagram of an example device in which several aspects of the present invention can be implemented. The block diagram shows mobile phone 100, which is in turn shown containing GPS receiver 150, GSM (Global System for Mobile Communication) block 151, WLAN (wireless local area network) block 152, blue tooth (BT) block 153, WCDMA block 154, application block 160, display 170, input/output (I/O) block 180, and memory 190. The components/blocks of mobile phone 100 in FIG. 1 are shown merely by way of illustration. However, mobile phone 100 may contain more or fewer components/blocks. Further, while in the examples below, blanking techniques are described with respect to GPS receivers, the techniques can be applied in the context of other types of receivers (whether wireless or wireline), and in other environments as well.

GPS receiver 150 is shown containing GPS processing block 110, filter 115 and GPS antenna 105. GSM block 151 is shown containing GSM transceiver 120 and transmit antenna 106. WLAN (Wireless LAN) block 152 is shown containing WLAN transceiver 130 and transmit antenna 107. Blue tooth (BT) block 153 is shown containing BT transceiver 140 and transmit antenna 108. WCDMA block 154 is shown containing WCDMA (Wideband Code Division multiple Access) transceiver 145 and transmit antenna 109. GSM block 151, WLAN block 152, BT block 153 and WCDMA block 154 may contain respective receive antennas and filters as well, but are not shown in FIG. 1.

Blocks 110, 120, 130, 140 and 145 may be implemented, for example, as separate integrated circuits (IC), or implemented on a single IC. Typically, the components (ICs, filter and antennas) of FIG. 1 are mounted on a printed circuit board (PCB), with corresponding tracks providing the electrical connectivity represented by paths 111, 101, 126, 137, 148 and 149.

GSM block 151 operates to provide wireless telephone operations, with GSM transceiver 120 containing receiver and transmitter sections to perform the corresponding receive and transmit functions. WCDMA block 154 operates to provide wireless telephone features according to WCDMA techniques. Similarly, each of WLAN block 152, and BT block 153 provides wireless (data and/or voice) communication (receive as well as transmit) according to the corresponding techniques/protocols.

GPS antenna 105 receives satellite signals from GPS satellites, and provides the satellite signals to filter 115 via path 101. Filter 115, which may be implemented as a surface acoustic wave (SAW) filter, provides band-pass filtering to the satellite signals received on path 101, and provides filtered signals to GPS processing block 110 via path 111. Either of paths 111 or 101 may be viewed (and referred to below) as an input path of GPS receiver 150. GPS processing block 110 processes the received GPS signals, decodes/demodulates the signals, extracts data contained in the signals, and computes the position of GPS receiver 150.

Application block 160 may contain corresponding hardware circuitry (e.g., processors), and operates to provide various user applications provided by mobile phone 100. The user applications may include voice call operations, data transfers, providing positioning information, etc. Application block 160 may operate in conjunction with blocks 150-154 to provide such features, and communicates with the respective blocks 150-154 via paths 161-165.

Display 170 displays image frames in response to the corresponding display signals received from application block 160 on path 176. The images may be generated by a camera provided in mobile phone 100, but not shown in FIG. 1. Display 170 may contain memory (frame buffer) internally for temporary storage of pixel values for image refresh purposes, and may be implemented, for example, as a liquid crystal display screen with associated control circuits. I/O block 180 provides a user with the facility to provide inputs via path 186, for example, to dial numbers. In addition I/O block 180 may provide outputs (on path 186 that may be received via application block 160. Such outputs may include position, data, images etc.

Memory 190 stores program (instructions) and/or data (provided via path 196) used by applications block 160, and may be implemented as RAM, ROM, flash, etc, and thus contains volatile as well as non-volatile storage elements.

Transmissions by GSM block 151, WLAN block 152, BT block 153 or WCDMA block 154 that fall within the receive band of GPS receiver 150 (and propagated on paths 111 or 101) may interfere with the normal operations of GPS receiver 150 (or GPS processing block 110), thereby potentially degrading the sensitivity of the receiver or causing complete disruption of normal operations. As an example, the bandwidth of interest of GPS receiver 150 (assuming an LI C/A band receiver) is 1575.42±1 MHz.

Transmissions (for example, spurious missions due to insufficient transmit filtering from one or more of blocks 160, 170 and 180 falling within the bandwidth of interest) may be received by GPS processing block 110 via antenna 105, filter 115 and input path 111). Such transmissions represent jamming interference with respect to GPS receiver 150. In this document, the terms ‘jamming signal’, ‘interference’ and ‘jamming interference’ are used interchangeably, and all have the same meaning(s).

As another example, transmit signals from WLAN block 152 and GSM block 151 on respective paths 137 and 126 may be coupled (e.g., by electromagnetic induction, due to proximity of the paths) into path 101 due to the manner in which the paths are physically provided on a PCB. Assuming GSM signals on path 126 are in the band 824-849 MHz, and BT signals on path 148 are in the band 2402-2480 MHz, non-linear characteristics of filter 115 (implemented, for example, as a SAW filter) may cause the generation of interference falling in the bandwidth of interest of GPS receiver 150. For example, non-linearity of filter 115 may cause the generation of an inter-modulation product of frequency of approximately 1575 MHz, which is within the bandwidth of interest of GPS receiver 150, and thus constitutes interference. It is noted such interference due to inter-modulation products may be particularly strong (and hence disruptive) when transmissions from WCDMA block 154 mix with WLAN signals in filter 115. Other sources, such as devices external to mobile phone 100, may also be potential sources of interference.

Unless measures are taken, the interference may cause undesirable effects in receivers. For example, a GPS receiver may not be able to continue to compute positions accurately since the GPS signal itself is weak, compared to possible strength of interference signals in several situations. As noted above, blanking is often used to minimize the adverse effects of jamming interference, and is illustrated next. First, however, the details of a receiver in an embodiment of the present invention are provided.

2. Receiver

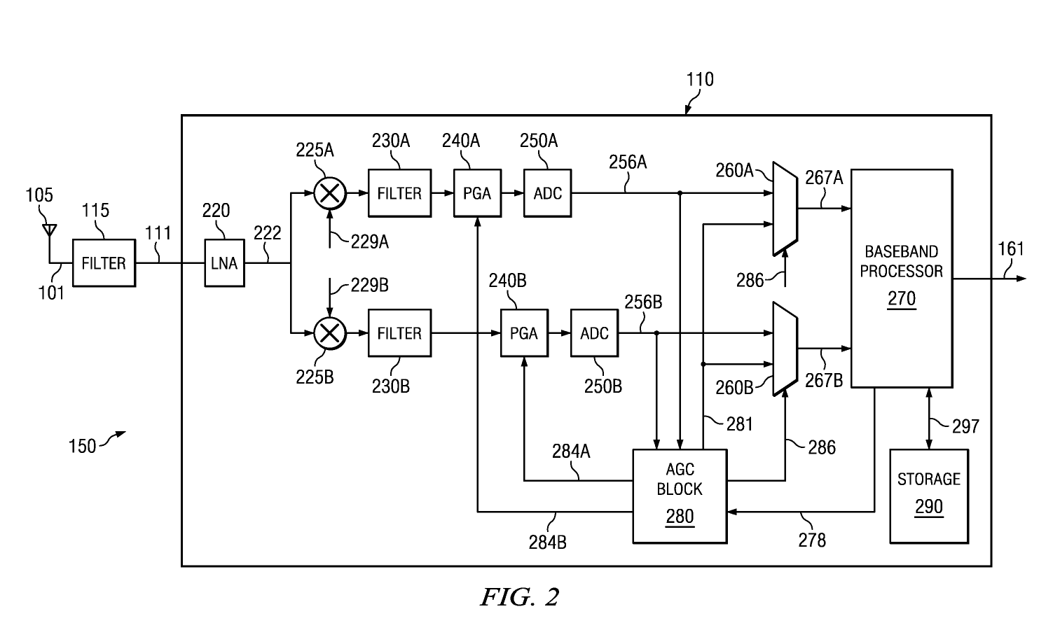

FIG. 2 is a block diagram of a receiver in an embodiment of the present invention. GPS receiver 150 is shown containing GPS antenna 105, filter 115, low-noise amplifier (LNA) 220, mixers 225A and 225B, filters 230A and 230B, programmable gain amplifiers (PGA) 240A and 240B, analog to digital converters (ADC) 250A and 250B, multiplexers (MUX) 260A and 260B, baseband processor 270, automatic gain control block (AGC) 280, and storage 290. Again, the details are provided merely by way of illustration, and other designs/implementations are also possible.

Filter 115 and GPS antenna 105 operate as described above with respect to FIG. 1. The band-pass characteristics of filter 115 (e.g., implemented as a SAW filter) are selected corresponding to the desired bandwidth of interest of GPS receiver 150. Filter 115 provides band-pass filtered signals on path 111 to LNA 220. Either of paths 101 and 111 is referred to below as ‘input path’ of GPS receiver 150.

LNA 220 amplifies signals on input path 111 with minimal addition of noise, and provides the amplified signals (on path 222) to each of mixers 225A and 225B. Mixers 225A and 225B operate to down-convert signals on path 222 to a lower frequency (e.g., an intermediate frequency (IF), or a final baseband frequency depending on the specific implementation).

Mixer 225A receives a local oscillator (LO) signal (I-component) on path 229A, and multiplies the LO signal with the signal 222 to generate an output that is provided to filter 230A. Mixer 225B receives a local oscillator (LO) signal (Q component, 90 degrees phase shifted from the I-component) on path 229A, and multiplies the LO signal with the signal 222 to generate an output that is provided to filter 230B. Filters 230A and 230B remove (filter) the undesired side-band outputs generated by the respective mixers, and provide corresponding down-converted I and Q signals to respective PGAs 240A and 240B.

PGAs 240A and 240B receive corresponding gain values on respective paths 284B and 284A, and amplify the respective inputs received from respective filters 230A and 230B by the corresponding received gain values. PGAs 240A and 240B provide the respective gain signals to respective ADCs 250A and 250B. In alternative embodiments, PGAs 240A and 240B may not be implemented separately, and the programmable gain may instead be integrated into the basic operation/function of ADCs 250A and 250B.

ADCs 250A and 250B sample the respective inputs received from the PGAs, and generate corresponding digital codes representing the strengths of the sampled input. ADCs 250A and 250B provide the respective sequences of digital codes on respective paths 256A and 256B.

Multiplexer (MUX) 260A forwards one of the inputs on paths 256A and 281 on path 267A, based on the binary value of select signal 286. Similarly, MUX 260B forwards one of the inputs on paths 256B and 281 on path 267B, based on the binary value of select signal 286.

Baseband processor 270 processes the inputs received on paths 267A and 267B, to determine the position of GPS receiver 150. Baseband processor 270 may contain hardware acceleration blocks such as hardware correlators, in addition to general purpose processing blocks. Baseband processor 270 provides on path 161 (to application block 160) outputs such as position, time, and any other desired parameters (for example, parameters generated during internal processing, or raw data received from GPS satellites). The outputs may be used by various user applications noted above.

Storage 290 stores data values (received via path 297) extracted by baseband processor 270 from corresponding GPS signals. Various intermediate data values generated during processing of signals by baseband processor 270 are also stored in storage 290. In addition, assuming baseband processor 270 operates using instructions (rather than as a hardwired component such as FPGA, ASIC, etc.) the corresponding program (instructions) and/or data may also be stored in storage 290. Storage 290 may be implemented as RAM, ROM, flash, etc, and thus contains volatile as well as non-volatile storage elements.

AGC block 280 receives digital codes on paths 256A and 256B, and determines the amplitude of the signal represented by the codes. Based on the amplitude determined, AGC 280 may increase or decrease the gain of PGAs 240A and 240B. When no interference is determined to be present, AGC block 280 typically operates to adjust the gain of the PGAs such that a substantially constant amplitude level is maintained in the signal represented by the digital codes.

Thus, in the absence of interference, the gain values provided to the PGAs is greater for a smaller amplitude of the ‘desired’ signal (GPS signal in the receiver of FIG. 2) in the input path, and smaller for a larger amplitude of the desired signal. The amplitude of the desired signal may be determined by baseband processor 270. In the context of GPS signals, such amplitude is determined by correlation operations, as is well known in the relevant arts, and indicated by baseband processor 270 to AGC block 280 via path 278.

However, in other implementations, the gain values for PGAs 240A and 240B even in the absence of interference may be determined by AGC block 280 based on the sample values received on paths 256A and 256B. It is noted here (and also well-known in the relevant arts) that the desired signal strength of a GPS signal is typically much weaker than thermal noise generated by GPS receiver 150. Hence, gain values provided to PGAs 240A and 240B are determined according to the amplitude of the thermal noise (or any other dominant noise source) of GPS receiver 150 rather than the “strength” of the GPS signal transmitted from satellites.

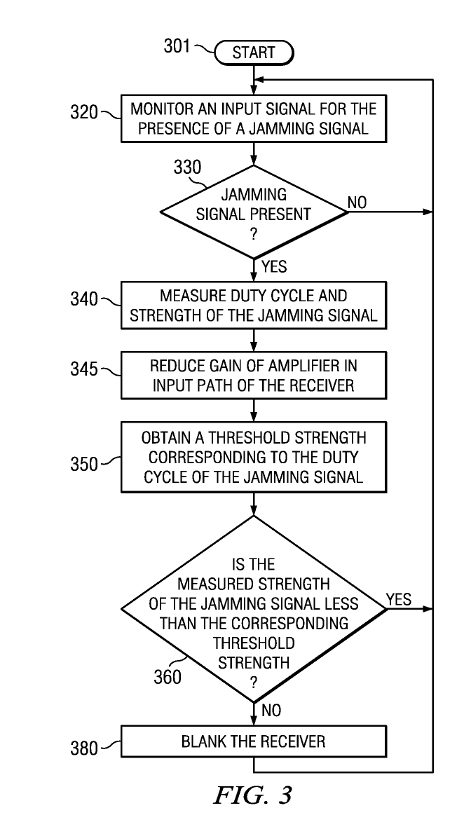

However, when AGC block 280 detects interference on the input path of GPS receiver 150, AGC block 280 may either provide a blanking signal (e.g., digital codes with a predetermined value, for example, binary zero) on path 281, or reduce the gain of PGAs 240A and 240B, as described below with respect to FIG. 3.

While AGC block 280 is shown as a block separate from baseband processor 270, in other embodiments of the present invention, the operations of AGC block 280 may be integrated within (provided by) baseband processor 270. Further, alternative embodiments of the present invention can be implemented with greater or lesser level of integration and/or different techniques and blocks from those shown in FIG. 2, as will be apparent to one skilled in the relevant arts.

In an embodiment of the present invention, AGC block 280 operates (in addition to the functions noted above) to determine if jamming interference is present or not, and to operate to mitigate the effects of such interference, as described next with respect to a flowchart.

3. Interference Mitigation

FIG. 3 is a flowchart illustrating the manner in which interference mitigation is provided in a receiver, in an embodiment of the present invention. The flowchart is described with respect to the device and components of FIGS. 1 and 2, and in relation to AGC block of a GPS receiver, merely for illustration. However, various features described herein can be implemented in other environments and using other components, as will be apparent to one skilled in the relevant arts by reading the disclosure provided herein.

Furthermore, the steps in the flowchart are described in a specific sequence merely for illustration. Alternative embodiments using a different sequence of steps can also be implemented without departing from the scope and spirit of several aspects of the present invention, as will be apparent to one skilled in the relevant arts by reading the disclosure provided herein. The flowchart starts in step 301, in which control passes immediately to step 320.

In step 320, AGC block 280 monitors the input signal for the presence of a jamming signal (interference). Monitoring implies that the strength of the input signal is examined. The input signal is shown received on path 101, filtered in filter 230A and shown provided as digital samples to baseband processor 270. AGC block 280 determines/detects the presence of jamming signal(s), for example, by checking if sample values in the input path have energy (in theory, defined as amplitudes summed/integrated over an interval of time) greater than that expected if no jamming signals were present.

In an embodiment, AGC block 280 adds received signal values contained in one or more of corresponding time windows to determine the corresponding energy level, and compares the sum with a threshold. With respect to FIG. 2, the threshold is typically equal to a value (offset+noise floor of GPS receiver 150), the offset being pre-computed and stored in GPS receiver 150. (Example offset are noted in column two of the table of FIG. 5) A sum greater than the (threshold) value is deemed to indicate the presence of a jamming signal in the input path. In an embodiment, AGC block 280 computes the average of squared values of signal samples received in a time interval. AGC block 280 then compares the computed average with the threshold to determine whether jamming has occurred (is present) or not.

In an alternative embodiment, AGC block 280 computes the average of the sample values in a time window. AGC block 280 then compares the average with the threshold, and if the average is greater than the threshold, AGC block 280 determines that a jamming signal is present. Control then passes to step 330.

In step 330, AGC block 280 determines if a jamming signal is present. If a jamming signal is deemed to be present (e.g., using techniques noted above), control passes to step 340, otherwise control passes to step 320.

In step 340, AGC block 280 measures the duty cycle as well as a strength (amplitude level) of the jamming signal (detected or deemed to be present as noted above). As is well known, the duty cycle is generally computed as the ratio of ON time and the sum of ON time and OFF time. It may be appreciated that determination of the duty cycle of the jamming signal may require several occurrences of the jamming signal. AGC block 280 may therefore record the times of occurrences (e.g., start and end) of the jamming signal over a period of time (e.g., several seconds), and then compute the time difference between the end instance of the jamming signal and the immediately next start instance of the jamming signal. Based on the above computations, AGC 280 may then compute the duty cycle of the jamming signal. During the initial duration of operation of GPS receiver 150, (e.g., immediately after power-ON) AGC block 280 may select a pre-determined value for the duty cycle. The pre-determined value may be based on past history (past occurrences of jamming signals), or may be pre-computed and stored in GPS receiver 150.

In an embodiment, AGC block 280 determines the strength of the jamming signal as the average power level of the jamming signal, obtained by averaging the squared values of the samples contained during an interval (ON interval) in which the jamming signal is present. However, in alternative embodiments, AGC block 280 may use other indicators of the strength (measured strength) a jamming signal, such as, for example, summed sample magnitudes over a time window. In general, the measured strength represents the amount by which the noise floor of the receiver has increased from a value corresponding to when the jamming signal is absent. Control then passes to 345.

In step 345, AGC block 280 reduces the gain of an amplifier in a path from the input path to a baseband processor. To illustrate with respect to FIG. 2, AGC block 280 may reduce the gain provided by PGAs 240A and/or 240B (or the gain of ADCs 250A and 250B) for the duration of the jamming signal. In an embodiment, AGC block 280 reduces the gain of PGAs 240A and 240B by a value equal (in decibels) to the measured strength of the jamming signal. Control then passes to step 350.

In step 350, AGC block 280 obtains a threshold strength corresponding to the duty cycle of the jamming signal determined in step 340. The threshold strength, which may be determined a priori as a function of duty cycle, ensures that optimal receiver performance is obtained for all jammer power levels and all duty cycles. For example, if actual duty cycle of the jammer (jamming signal) is 70%, but is assumed to be 30%, then, suboptimal receiver performance is obtained if jammer is 8 dB stronger than receiver noise floor. In an embodiment, the threshold strengths are designed to have a positive correlation (i.e., a higher threshold is generally selected for correspondingly higher duty cycle value) with respect to duty cycles. Control then passes to 360.

In step 360, AGC block 280 determines if the measured strength of the jamming signal is less than the threshold strength. If the measured strength is less than the threshold strength, control passes to step 320, otherwise control passes to step 380.

In step 380, AGC block 280 blanks GPS receiver 150. With respect to FIG. 2, blanking (also referred to as receiver blanking) is performed by blocking the input signal to baseband processor 270. The ‘normal’ input (e.g., digital codes on paths 256A and 256B) is blocked from being propagated further, and a (constant) digital value of zero (i.e., representing ground or no input signal) is instead provided. Control then passes to step 320, and the flow chart may be repeated with respect to subsequent segments (portions) of the input signal received on path 101.

It may be appreciated that the technique described above does not require an external indication of a possible presence of interference, as may be employed in some prior approaches. Such prior approaches may lead to less-than-optimal solutions at least for the reason that the interference indication may be provided even when the actual interference falls outside of the receivers' band of interest (receiver input band). For example, GSM signals may be broadcast in any of several frequency bands, not all of which may fall (at least partially) within a receivers input band. Further, such prior approaches may not take into account the strength of the interference, thereby causing the receiver not to use information in the modulated signal.

Thus, according to an aspect of the present invention, interference detection is performed within the receiver itself based on the signal levels (represented by amplitudes of the samples) of the input signal. Further, both the strength as well as the duty cycle of the interference are determined, and the specific interference mitigation approach is based on both the strength as well as the duty cycle of the interference signal. Thus, for example, when the measured strength (step 360) is less than the corresponding threshold strength (set based on the duty cycle of the interference), the receiver may not be blanked, but only a signal gain reduced (step 345).

Therefore, the receiver may continue to operate normally to recover information contained in the input signal (GPS raw data in the example of FIG. 2) even in the presence of interference if such interference is weak enough not to cause significant degradation in the sensitivity of the receiver in extracting and processing the signal of interest (GPS signals in example of FIG. 2). The receiver may be blanked only when the measured strength exceeds the corresponding threshold strength.

In several operating scenarios (such as, for example, in the presence of GSM transmissions), the interference may be periodic/cyclical. In an embodiment, prior to blanking the receiver, AGC block 280 may determine the start and end time instances of the interference, as well as the time period of the interference. The manner in which such determination is done is described next with respect to an example waveform.

4. Detection of Start and End of Interference

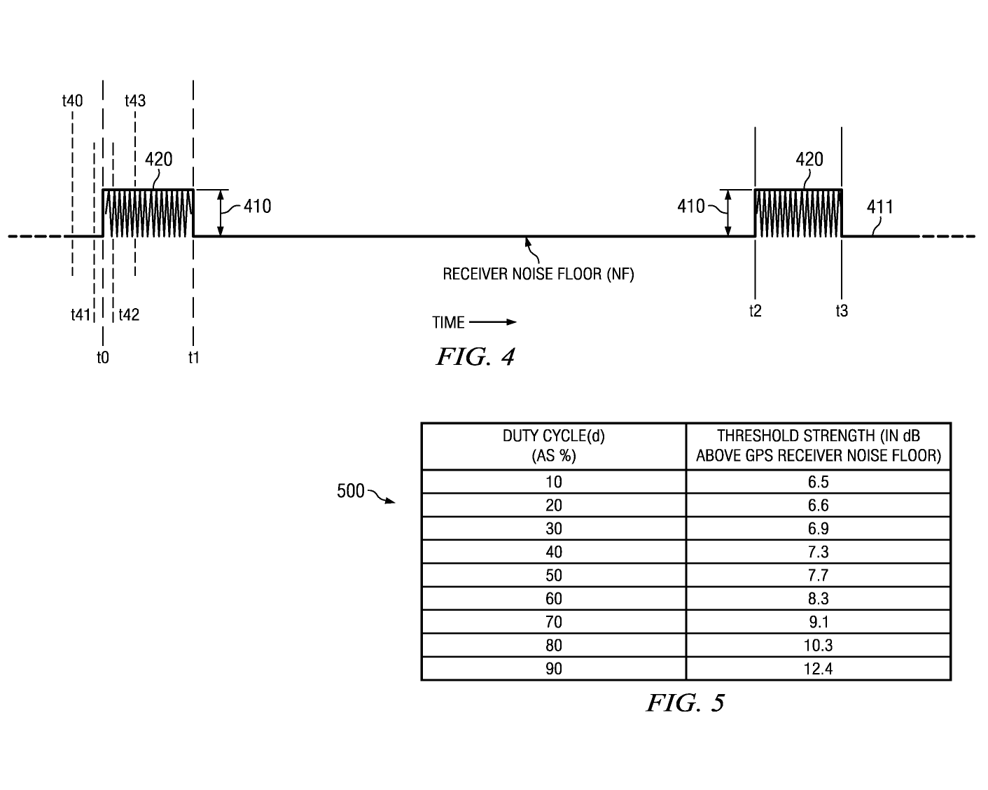

FIG. 4 is a diagram used to illustrate the manner in which the start and end points of a periodic interference is detected, in an embodiment of the present invention. The diagram is shown containing waveform 411, which represents levels of the input signal of GPS receiver 150. Interference signal 420 is shown as being present (ON) in intervals (time windows) t0-t1 and t2-t3. Time interval t0-t2 represents one cycle of the interference, which is assumed to repeat with the same period starting from time instance t2.

A portion of the next cycle (starting from time instance t2) is also shown. Merely for illustration, both ON intervals (t0-t1) as well as (t2-t3) are shown as having the same strength 410. However, in general, the strength of the jamming signal may vary from cycle to cycle. Further, portion/segment t1-t2 of input signal 411 is shown as representing the receivers noise floor (NF) even though GPS signals (modulated signals) may be present in the interval t1-t2, since GPS signals typically have very low signal strengths, and are buried in noise, as is well known in the relevant arts.

It may be appreciated that the start of the jamming signal may first need to be determined. In an embodiment, AGC block 280 adds digital values of samples provided on each of paths 256A and 256B for the duration of short time intervals (detection windows). AGC block 280 adds digital values on paths 256A and 256B for the duration of a detection window, and then adds the individual sums (obtained for each of paths 256A and 256B) to obtain a final sum. AGC block 280 compares the final sum with a threshold (noise floor of GPS receiver 150 in the example of FIG. 2). If the final sum corresponding to a ‘current’ detection window is greater than the threshold, but a final sum for an immediately previous detection window is not greater than the threshold, AGC block 280 concludes that the start of the ON duration of the jamming signal has occurred in the ‘current’ detection window.

As an illustration, three short detection windows represented by corresponding time intervals t40-t41, t41-t42 and t42-t43 are shown in FIG. 4. It may be observed that the sums of sample values in each of windows t41-t42 and t42-t43 would be greater than a threshold represented by the receiver noise floor power level (NF), while sum in window t0-t1 would (approximately) equal the NF. Assuming detection window t41-t42 to corresponds to a currently received set of sample values, since the sum of the sample values in detection window t41-t42 is greater than the threshold, while the sum in the previous detection window is equal to the threshold, AGC block 280 concludes that the start of the jamming signal has occurred in the ‘current’ detection window t41-t42.

In an embodiment, the width (time duration) of the detection windows is selected to be much shorter than an ‘expected duty cycle’ (which may range for example, from 2% to 85%) or ON duration of a potential jamming signal. It is noted here that, at least in some operating scenarios, the ‘expected duty cycle’ or the ON duration of a potential jamming signal may be reasonably assumed or estimated. For example, transmit durations (ON times) as well as transmit repetition intervals of GSM transmitters (e.g., contained in GSM transceiver 120) are often fixed by the corresponding standard, and may therefore be reasonably well predicted.

In an embodiment, the sum of sample values in a detection window is computed according to the following equation:

$${Q}_{n} = {\sum }_{k = 1}^{N} W ( k ) {x}_{k}^{2} \qquad Equation 1$$

wherein,

xₖ represents the value of the k^{th} sample, for values of k from 1 to N, N being the total number of samples in a detection window,
W(k) is a windowing or weighting function used for the detection window, with the weights specified by W(k) having a greater value for greater values of index ‘k’.

In an embodiment, windowing function W(k) has the following form/expression:

$$W ( k ) = \{ \begin{matrix}1 , k < \frac{N}{2} \\ 2 , \frac{N}{2} \leq k < \frac{3 N}{4} \\ 4 , \frac{3 N}{4} \leq k < \frac{7 N}{8} \\ 8 , k \geq \frac{7 N}{8}\end{matrix}$$

In yet another embodiment, windowing function W(k) has the following form/expression:

W(k)=k²

Since the values of windowing function W(k) increase as the index ‘k’ increases, samples closer to the end the detection window are provided greater weight. Such a windowing technique enables better detection of a jamming signal that begins late in the integration cycle. The detection windows employed in the embodiment may be non-overlapping. However, in other embodiments, each detection window may be selected to overlap with previous and next detection windows, to enable quicker detection of a potential jamming signal. While windowing function W(k) is described above as being used for detection of a jamming signal (i.e., when receiver has not yet detected a jammer), it can also be used for detection of “end of jamming signal” after the jamming signal has been detected.

By similarly summing sample values in corresponding detection windows (not shown) in other portions of waveform 411, AGC block 280 determines the end of the ON interval (e.g., time instance t1 in FIG. 4). As will be readily appreciated, the sum of samples would need to be lower than a threshold, for the end of the ON interval to be detected. In a similar manner AGC block 280 also determines the end of a cycle and thus the time period (time interval t0-t2 in FIG. 4) of jamming signal 420. As will be appreciated, the end of a cycle may be determined in a manner similar to determination of start of a cycle described above.

Having thus determined the ON interval and the time period of jamming signal 420, AGC block 280 computes the duty cycle as the ratio of the ON interval (t0-t1) and the time period (t0-t2) of the cycle of the jamming signal. In an embodiment, AGC block 280 computes the average value of the duty cycles (computed as described above) over an interval of time, and uses the average value in further operations. AGC block 280 may then determine the strength of the jamming signal, as described next.

5. Measuring the Strength of Interference

In an embodiment, AGC block 280 determines the strength of the jamming signal by averaging the squared values (average power) of the samples contained during ON interval (t0-t1), as noted above, though alternative approaches can be used to measure the strength of the jamming signal. The value of the average thus obtained is subtracted from the noise floor (NF) of the receiver, and the difference represents the strength of the jamming signal. In FIG. 4, the average power of jamming signal 420 is denoted by marker 410.

In an embodiment, to determine the NF of the receiver, AGC block 280 computes the average value of the square of the sample values on either of paths 256A and 256B for the duration of a time interval of several seconds (e.g., 5 seconds). AGC block 280 then subtracts a value representing the current gain setting in the corresponding PGA (i.e., PGA 240A if the average value is computed based on samples on path 256A, and PGA 240B if the average value is computed based on samples on path 256B). AGC block 280 may repeat the operation of above for multiple (5-second) time intervals, and selects the least difference obtained as the NF, which is then used, as noted above, as the reference for measurements of jamming signal strengths. It may be appreciated that the NF computed as described above represents the noise floor as would be measured at output 222 of LNA 220.

It is noted that noise floor (NF) of GPS receiver 150 may vary with respect to time. Further, noise floor may also be different for different GPS receivers. It may be appreciated from FIG. 4, that since jamming signal strengths (e.g., as indicated by 410 in FIG. 4) are measured with respect to the NF, it may be required to compute (or recalibrate) the NF at regular intervals. According to an aspect of the present invention, AGC block 280 computes the NF at regular intervals (e.g., every few seconds throughout the duration of operation of GPS receiver 150). It may be appreciated that the regular recalibration of the NF enables an accurate determination of the strength of jamming signals, since jamming signal strength is measured relative to the NF.

Having thus, determined the strength of the jamming signal, AGC block 280 determines the specific type of interference mitigation (gain reduction alone, or blanking in addition to gain reduction), as described next.

6. Applying Interference Mitigation

As noted above with respect to the flowchart of FIG. 3, AGC block 280 compares the measured strength of a jamming signal with a threshold strength corresponding to the duty cycle of the jamming signal. In an embodiment, values of duty cycles and corresponding threshold strengths are determined with the goal of recovering information from GPS signals (modulated signal in the example of FIG. 2) in as many situations as possible. However, alternative approaches can be used to determine the threshold strengths. The duty cycles and corresponding threshold values (shown in table 500 of FIG. 5) may thus be pre-computed and stored (for example, in the form of a table, in storage 290) for quick access. FIG. 5 shows an example table (500) containing as entries, duty cycle values and corresponding threshold strengths. Table 500 is shown merely by way of illustration, and typically more table entries (more number of duty cycle values and corresponding threshold strengths) may be used.

Column 1 of table 500 contains the duty cycle entries, with the duty cycles expressed as a percentage. Column 2 of table 500 contains corresponding threshold strength entries, which are specified in decibels above the noise floor of GPS receiver 150. It may also be observed from table 500 that the threshold strengths have a positive correlation with the duty cycle of the interference.

As noted above with respect to step 320 of the flowchart of FIG. 3, AGC block 280 compares the sum of the value in column 2 of table 500 (assuming duty cycle is determined to equal the corresponding value in column 1) and the current average value of the receiver NF computed with the received signal values contained in corresponding time windows. For example if the receiver NF is −40 dBm, and the ‘threshold strength’ corresponding to the duty cycle (e.g., 10%) of the jamming signal is 6.5 dB, AGC block 280 compares the received signal values with −33.5 dB (i.e., −40+6.5 dBm).

7. Example Operation

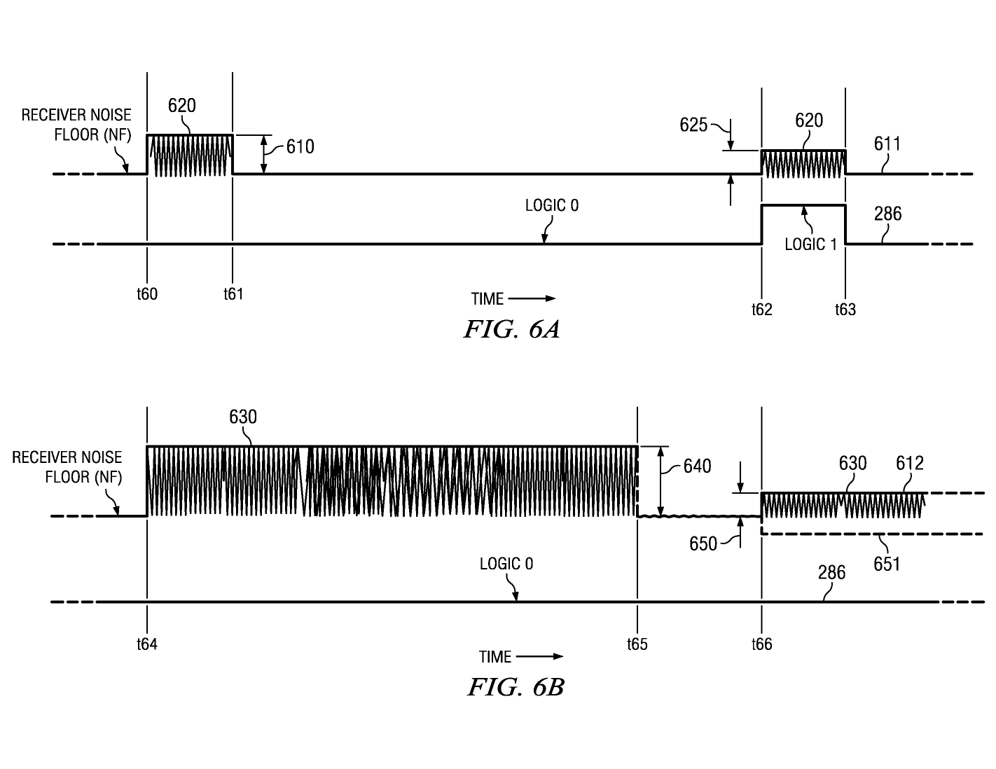

FIGS. 6A and 6B are example waveforms used to illustrate the operation of AGC block 280 in mitigating interference. It is assumed in the description below that AGC block 280 computes the duty cycle and strength of the jamming signal, and determines whether blanking is to be applied or not prior to jamming signal occurrences in interval t62-t63 (FIG. 6A) and t66 onwards (FIG. 6B). Further, duty cycle is noted below as being computed based on measurements of the immediately preceding cycle of the jamming signal (interval t60-t62 in FIG. 6A, and t64 to t66 in FIG. 6B) merely for illustration. It is noted again that in practice, AGC block 280 uses an average value of duty cycles determined over a much longer duration (e.g., several seconds).

Waveform 611 of FIG. 6A represents example signal strengths of the input signal of GPS receiver 150 with respect to time, when interference is present. The strength of jamming signal 620 in ON interval (t60-t61) is represented by marker 610. The duty cycle of the jamming signal equals [(t61-t60)/(t62-t60)].

Assuming that the duty cycle is 20%, and if jamming signal strength 610 is greater than the corresponding threshold strength (6.6 dB in table 500, corresponding to the 20% duty cycle), AGC block 280 blanks GPS receiver 150 (corresponding to step 380 of FIG. 3) for the duration of the ON interval of future time periods (cycles) of the jamming signal. ON interval t62-t63 of a next cycle is shown in FIG. 6A. Assuming that the duty cycle and strength of jamming signal 620 is determined prior to time instance t62 (as noted above), the receiver is blanked starting from time instance t62 when processing the signal segment starting from t62. Such blanking is continued for all future ON durations of the jamming signal.

To blank GPS receiver 150, AGC block 280 provides select signal 286 (shown in FIG. 6A as a logic high in time interval t62-t63) to cause MUX 260A and 260B (FIG. 2) to provide input 281 on each of paths 267A and 267B. AGC block 280 may provide a constant value (e.g., binary zero) on path 281, thereby providing baseband processor 270 with a known constant (or zero-valued) input signal. It is assumed in FIG. 6A, that AGC block 280 utilizes at least time interval t60-t62 to measure the strength and duty cycle of the interference. Blanking pulse is shown as being applied in the next ON interval t62-t63, in which select signal 286 is indicated as being logic high to provide constant input 281 on paths 267A and 267B. In addition, AGC block 280 also reduces the gain of PGAs 240A and 240B (or ADCs 250A and 250B), as reflected by the reduced strength 625 of jamming signal 620 in the interval t62-t63.

Waveform 612 of FIG. 6B illustrates another example of signal levels with respect to time on the receiver's input path when interference is present. In the Figure, the strength of jamming signal 630 in ON interval (t60-t61) is represented by marker 640. The duty cycle of jamming signal 630 equals [(t65-t64)/(t66-t64)]. Assuming that the duty cycle is 80%, and if jamming signal strength 640 is less than the corresponding threshold strength (10.3 dB in table 500, corresponding to the 80% duty cycle), AGC block 280 only reduces the gain of PGAs 240A and 240B (or ADCs 250A and 250B) for the ON duration of jamming signal 630 in future cycles.

ON interval of a next cycle starting at t66 is partially shown in FIG. 6B, with the gain shown reduced to a level 650. Although jamming signal 630 is shown as having a reduced strength (650) greater than the receiver noise floor, in some implementations, the gain is reduced such that the signal level equals the noise floor, i.e., gain is reduced by strength 640 (in dB). Alternatively, the gain reduction may be provided such that the NF is itself reduced, (for example, to level denoted by dotted line 651). It is noted that ideally it may be desirable to apply a gain reduction of 2X dB for a jamming signal strength of X dB. However, in practical scenarios it may not be feasible to provide such a large change in gain (e.g., assuming the jamming signal strength is 10 dB, the ideal gain reduction may be 20 dB, which is large value). Therefore, in practical situations, the gain reduction may be limited to X dB or less.

To reduce gain, AGC block 280 provides (or maintains) select signal 286 (shown in FIG. 6B as a logic low continuously), to cause MUX 260A and 260B to provide signals on paths 256A and 256B to baseband processor 270 via respective paths 267A and 267B. AGC block 280 does not apply any blanking pulse(s). In general, gain reduction may be provided to reduce the amplitude of the jamming signal by a power level equal to the determined strength (6.6 dB in the example). However, smaller or greater gain reductions may also be provided based, for example, on the specific operating environments, sensitivity of the receiver, etc.

AGC block 280 similarly measures duty cycles and strengths of the jamming signal for future cycles of a jamming signal. AGC block 280 performs the corresponding interference mitigation operation based on the measured strength, duty cycle and threshold strength corresponding to the measured duty cycle, as noted above. However, assuming the jamming signal's strength and duty cycle are substantially constant over several cycles (as may be the scenario for transmissions from GSM transceiver 120), the strength and duty cycle of the jamming signal may need to be measured only once, with the corresponding action (gain reduction or blanking) being applied for future cycles of the jamming signal till a change in the duty cycle and/or jamming signal strength is determined.

Thus, baseband processor 270 may not receive data representing the input signal 111 in durations jamming signal is detected. However, it may be appreciated that the jam signal pulses usually span a small fraction of the total duration required for extracting the GPS data and thus the operation (recovery of the data) may not be impacted due to the blanking during jam durations, described above. Detectability of the satellite signal may accordingly be enhanced.

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A receiver comprising:
an input path to receive an input signal containing a modulated signal bearing an information; and
a processing block coupled to receive said input signal and to recover said information,
said processing block to examine said input signal to detect an interference in said input signal,
said processing block to blank said receiver in response to detecting said interference.

2. The receiver of claim 1, wherein said processing block comprises:
a baseband processor to receive a first sequence of samples representing a first segment of said input signal, said baseband processor to process said first sequence of samples to recover said information; and
a second block to examine a second sequence of samples representing a second segment of said input signal to detect said interference,
wherein blanking said receiver comprises blocking to said baseband processor, in response to said second block detecting said interference, a third sequence of samples representing a third segment following said second segment.

3. The receiver of claim 2, wherein said processing block further comprises:
a mixer to down-convert said input signal to generate a baseband signal of a lower frequency compared to said input signal;
an amplifier to amplify said baseband signal based on a gain value, wherein said gain value is higher for lower amplitude of said input signal and lower for higher amplitude of said input signal when said interference is not present on said input path;
an analog to digital converter (ADC) to generate said sequence of samples by sampling said amplified baseband signal; and
a multiplexer to receive said sequence of samples on one input and a known value on a second input, said multiplexer to provide one of the two inputs to said baseband processor according to a select value,
wherein said select value is set to one binary value in case of detection of said interference and to another binary value otherwise, wherein said one binary value causes said receiver to be blanked.

4. The receiver of claim 3, wherein said processing block further comprises an automatic gain control (AGC) block to set said gain value based on an amplitude of said input signal,
said AGC block to also provide said select value.

5. The receiver of claim 4, wherein if said interference is present, said AGC block is operable to:
measure a duty cycle of a jamming signal constituting said interference, and a strength of said jamming signal if said jamming signal is deemed to be present;
set a threshold strength to a value having a positive correlation with said duty cycle;
reduce said gain value if said jamming signal is deemed to be present; and
if an amplitude of said jamming signal is greater than said threshold strength, then set said select value to said one binary value, and to said another binary value otherwise.

6. The receiver of claim 5, to detect said interference, said AGC block is further operable to:
add a set of successive samples in a detection window to form a sum, wherein said detection window is a short duration compared to a duration of said interference;
conclude said input signal contains said jamming signal if said sum is greater than a threshold value representing a noise floor, wherein said noise floor is calibrated at regular intervals.

7. The receiver of claim 1, further comprising:
a first antenna to receive a wireless signal in a first frequency band and to provide said input signal in said first frequency band on said input path to said processing block;
a band pass filter to filter said input signal before said input signal is provided to said processing block;
a second antenna; and
a transmitter to generate a transmit signal using said second antenna, wherein a jamming signal is generated on said input path due to said transmit signal.

8. The receiver of claim 4, wherein said interference is periodic with a duty cycle, wherein said second block determines said duty cycle by examining said second sequence of samples, and causes said select value to be thereafter set to said one binary value for the ON period of said duty cycle in a set of cycles of said third segment.

9. The receiver of claim 8, wherein said second block is comprised in said automatic gain control block, said modulated signal is a GPS signal and said interference comprises one of a GSM signal and WLAN signal.

10. A device comprising:
an application block to provide a user application by processing an information; and
a receiver to provide said information to said application block, said receiver comprising:
an input path to receive an input signal containing a modulated signal containing said information; and
a processing block coupled to receive said input signal and to recover the information contained in said modulated signal,
said processing block to examine said input signal to detect an interference on said input path,
said processing block to blank said receiver in response to detecting said interference.

11. The device of claim 10, wherein said processing block comprises:
a baseband processor to receive a first sequence of samples representing a first segment of said input signal, said baseband processor to process said first sequence of samples to recover said information; and
a second block to examine a second sequence of samples representing a second segment of said input signal to detect said interference,
wherein blanking said receiver comprises blocking to said baseband processor, in response to said second block detecting said interference, a third sequence of samples representing a third segment following said second segment.

12. The device of claim 11, wherein said processing block further comprises:
a mixer to down-convert said input signal to generate a baseband signal of a lower frequency compared to said input signal;
an amplifier to amplify said baseband signal based on a gain value, wherein said gain value is higher for lower amplitude of said input signal and lower for higher amplitude of said input signal when said interference is not present on said input path;
an analog to digital converter (ADC) to generate said sequence of samples by sampling said amplified baseband signal; and
a multiplexer to receive said sequence of samples on one input and a known value on a second input, said multiplexer to provide one of the two inputs to said baseband processor according to a select value,
wherein said select value is set to one binary value in case of detection of said interference and to another binary value otherwise.

13. The device of claim 12, wherein said processing block further comprises an automatic gain control (AGC) block to set said gain value based on an amplitude of said input signal,
said AGC block to also provide said select value,
said AGC block also comprising said second block.

14. The device of claim 13, wherein if said interference is present, said AGC block is operable to:
measure a duty cycle of a jamming signal constituting said interference, and a strength of said jamming signal if said jamming signal is deemed to be present; set a threshold strength to a value having a positive correlation with said duty cycle; reduce said gain value if said jamming signal is deemed to be present; and
if an amplitude of said jamming signal is greater than said threshold strength, then set said select value to said one binary value, and to said another binary value otherwise.

15. The device of claim 10, further comprising:
a first antenna to receive a wireless signal in a first frequency band and to provide said input signal in said first frequency band on said input path to said processing block;
a band pass filter to filter said input signal before said input signal is provided to said processing block;
a second antenna; and
a transmitter to generate a transmit signal using said second antenna, wherein a jamming signal is generated on said input path due to said transmit signal.

16. A method of mitigating the effects of interference in a receiver, said method being performed in said receiver, said method comprising:
examining an input signal received on an input path of said receiver to determine whether an interference is present on said input path;
blanking said receiver if said interference is present; and
recovering the information contained in a modulated signal contained in said input signal if said interference is determined not to be present.

17. The method of claim 16, further comprising:
sampling a first segment, a second segment and then a third segment of said input signal to generate a first sequence of samples, a second sequence of samples and a third sequence of samples respectively,
wherein said interference is cyclical with a time period in said second segment and said third segment,
wherein said examining examines said second sequence of samples to determine that said interference is present on said input path, said time period of said interference, and start and end points in said time period when said interference is present,
wherein said blanking is performed in said third segment in a set of cycles in said third segment between the start and end points in each of said set of cycles.

18. The method of claim 17, further comprising:
amplifying said input signal with a gain value before said recovering;
measuring a duty cycle of a jamming signal constituting said interference, and a strength of said jamming signal if said jamming signal is deemed to be present;
setting a threshold strength to a value having a positive correlation with said duty cycle; and
reducing said gain value if said jamming signal is deemed to be present.

19. The method of claim 18, further comprises:
sampling said input signal to generate a sequence of samples;
providing said sequence of samples to a baseband processor, which recovers information contained in said input signal, wherein said amplifying is performed prior to said providing,
wherein said blanking comprises blocking said sequence of samples from being provided to said baseband processor if said strength of said jamming signal is greater than said threshold strength.

20. The method of claim 18, wherein said examining comprises:
adding a set of samples representing a corresponding portion of said input signal in a detection window to generate a sum; and
concluding that said interference is present if said sum is greater than a threshold value,
wherein said measuring and said reducing are performed only if said concluding concludes that said interference is present.
